(19) United States
(12) Patent Application Publication
(10) Pub. No.: US 2022/0345446 A1
(43) Pub. Date: Oct. 27, 2022

(54) SESSION INITIATION PROTOCOL (SIP) AUTHENTICATION AND REGISTRATION IN SOFTWARE DEFINED PERIMETER (SDP) NETWORKS

(71) Applicant: Avaya Management L.P., Durham, NC (US)

(72) Inventor: Dragan Grebovic, Amesbury, MA (US)

(21) Appl. No.: 17/236,791

(22) Filed: Apr. 21, 2021

(51) Int. Cl. H04L 29/06

(52) U.S. Cl. CPC H04L 63/0209; H04L 63/08; H04L 63/101; H04L 65/1006; H04L 65/1073; H04L 65/1069; H04L 65/102

(57) ABSTRACT

Embodiments of the disclosure are directed to methods and systems for improving security of Session Initiation Protocol (SIP) calls in a Software Defined Network (SDN). In one embodiment a Software Defined Perimeter (SDP) gateway intercepts a SIP registration message from an initiating host to an accepting host for a SIP communication session. The SDP gateway further perform Single Packet Authentication (SPA) to determine if the initiating host is approved. In response to the initiating host being approved, the SDP gateway, adds the initiating host to a whitelist of the SDN. The SDP gateway also instructs the accepting host to accept a communication request from the initiating host for the SIP communication session.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

Embodiments of the present disclosure relate generally to methods and systems for improving security of Session Initiation Protocol (SIP) calls in Software Defined Networks.

### BACKGROUND

In the Session Initiation Protocol (SIP), a dialog for a communication is setup for different kinds of communications sessions, such as voice, video, text, and the like. The initial signaling to establish the dialog for the communication session is typically setup using a SIP proxy server and/or a Back-to-Back User Agent (B2BUA). Once the communication session is setup using the SIP Proxy server and/or the B2BUA, a media session may be created directly between user agents in SIP endpoint devices. For example, a SIP proxy server can setup an initial voice call between two SIP endpoint devices. Once the initial voice call is established by the proxy server, the communication session voice call can be setup (e.g., using Real-Time Protocol (RTP)) directly between the two communication devices.

A Software Defined Network (SDN) or a Software Defined Perimeter (SDP) controls access to resources based on identity. SDNs and SDPs are deployable anywhere (e.g., on the Internet, in the cloud, etc.). In SDNs and SDPs device identity is verified before access is granted. Such SDNs are “black” (e.g., inaccessible/invisible) as there are no visible Domain Name Server (DNS)/Internet Protocol (IP) addresses. SIP messages include information about how each host can be reached.

### BRIEF SUMMARY

Embodiments of the disclosure provide systems and methods for improving security of Session Initiation Protocol (SIP) calls in a Software Defined Network (SDN). Generally speaking, embodiments of the disclosure are directed to a Software Defined Perimeter (SDP) gateway. This gateway can act as a proxy for SIP User Agents (UA)s located in the SDN and can be included in the signaling path between UAs. More specifically, the SDP gateway can intercept a SIP registration message from an initiating host to an accepting host for a SIP communication session. The SDP gateway can further perform Single Packet Authentication (SPA) to determine if the initiating host is approved. In response to the initiating host being approved, the SDP gateway, adds the initiating host to a whitelist of the SDN. The SDP gateway also instructs the accepting host to accept a communication request from the initiating host for the SIP communication session.

### BRIEF DESCRIPTION OF THE DRAWINGS

FIG. 1 is a block diagram illustrating elements of a system for improving security of Session Initiation Protocol (SIP) calls in a Software Defined Network (SDN) according to one embodiment.

FIG. 2 is a flowchart illustrating additional details of an exemplary process for improving security of SIP calls in the SDN according to one embodiment.

FIG. 3 is a fencepost diagram illustrating one example of signaling between elements of a system utilizing an SDP gateway to improve security of SIP calls in a SDN according to one embodiment.

FIG. 4 is a fencepost diagram illustrating one example of signaling between elements of a system utilizing an SDP gateway to improve security of SIP calls in the SDN according to one embodiment.

FIG. 5 is a block diagram illustrating a computing system to for improving security of SIP calls in the SDN according to one embodiment.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the Session Initiation Protocol (SIP), a dialog for a communication is setup for different kinds of communications sessions, such as voice, video, text, and the like. The initial signaling to establish the dialog for the communication session is typically setup using a SIP proxy server and/or a Back-to-Back User Agent (B2BUA). Once the communication session is setup using the SIP Proxy server and/or the B2BUA, a media session may be created directly between user agents in SIP endpoint devices. For example, a SIP proxy server can setup an initial voice call between two SIP endpoint devices. Once the initial voice call is established by the proxy server, the communication session voice call can be setup (e.g., using Real-Time Protocol (RTP)) directly between the two communication devices.

A Software Defined Network (SDN) or a Software Defined Perimeter (SDP) controls access to resources based on identity. SDNs and SDPs are deployable anywhere (e.g., on the Internet, in the cloud, etc.). In SDNs and SDPs device identity is verified before access is granted. Such SDNs are “black” (e.g., inaccessible/invisible) as there are no visible Domain Name Server (DNS)/Internet Protocol (IP) addresses. A SDN or SDP creates a virtual closed user group that dynamically creates a virtual environment where only registered devices can see each other and where only permitted devices are allowed to register (e.g., whitelists). SIP messages may include information about how each host can be reached.

Embodiments of the disclosure provide systems and methods for improving security of Session Initiation Protocol (SIP) calls in a Software Defined Network (SDN). Generally speaking, embodiments of the disclosure are directed to a Software Defined Perimeter (SDP) gateway. This gateway can act as a proxy for SIP User Agents (UA)s located in the SDN and can be included in the signaling path between UAs. More specifically, the SDP gateway can intercept a SIP registration message from an initiating host to an accepting host for a SIP communication session. The SDP gateway can further perform Single Packet Authentication (SPA) to determine if the initiating host is approved. In other words, the interception of the SIP registration message allows for SPA before proceeding to any communication in a standard SIP environment. In response to the initiating host being approved, the SDP gateway, adds the initiating host to a whitelist of the SDN. The SDP gateway also instructs the accepting host to accept a communication request from the initiating host for the SIP communication session.

The methods and systems disclosed herein inherently prevent Denial of Service (DoS) attacks on protected equipment (e.g., servers, clients, etc.) and may also provide protection to networking equipment (e.g., routers, gateways, etc.). The methods and systems disclosed herein also prevent authentication spoofing, Man-In-The-Middle attacks, and vulnerability to network scanning, probing, mapping, penetration, etc.

In the following description, for the purposes of explanation, numerous specific details are set forth in order to provide a thorough understanding of various embodiments disclosure herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

The term “Session Initiation Protocol” (SIP) as used herein refers to an IETF-defined signaling protocol, widely used for controlling multimedia communication sessions such as voice and video calls over Internet Protocol (IP). The protocol can be used for creating, modifying and terminating two-party (unicast) or multiparty (multicast) sessions consisting of one or several media streams. The modification can involve changing addresses or ports, inviting more participants, and adding or deleting media streams. Other feasible application examples include video conferencing, streaming multimedia distribution, instant messaging, presence information, file transfer and online games. SIP is as described in RFC 3261, available from the Internet Engineering Task Force (IETF) Network Working Group, November 2000; this document and all other SIP RFCs describing SIP are hereby incorporated by reference in their entirety for all that they teach.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

Embodiments of the disclosure provide systems and methods for improving security of Session Initiation Protocol (SIP) calls in a Software Defined Networks (SDNs). Generally speaking, embodiments of the disclosure are directed to a Software Defined Perimeter (SDP) gateway. This gateway can act as a proxy for SIP User Agents (UA)s located in the SDN and can be included in the signaling path between UAs. More specifically, the SDP gateway can intercept a SIP registration message from an initiating host to an accepting host for a SIP communication session. The SDP gateway can further perform Single Packet Authentication (SPA) to determine if the initiating host is approved. In response to the initiating host being approved, the SDP gateway, adds the initiating host to a whitelist of the SDN. The SDP gateway also instructs the accepting host to accept a communication request from the initiating host for the SIP communication session.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

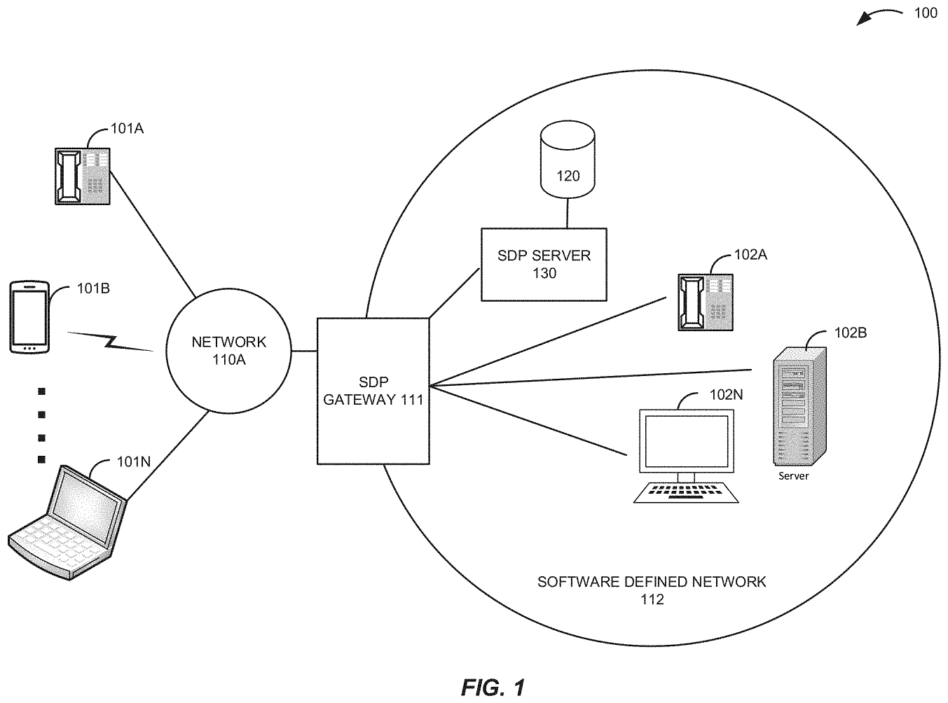

FIG. 1 is a block diagram illustrating elements of a system 100 according to one embodiment. As illustrated in this example, the system 100 can comprise a number of user agents (UAs) 101A-N and 102A-N. The user agents 101A-N and 102A-N can be any hardware/software that can process SIP communications such as a SIP telephone application, a SIP Instant Messaging (IM) application, a SIP video conference application, a SIP email application, a SIP softphone in a PC, a SIP application in a set-top box, and the like.

The user agents 101A-N and 102A-N may be implemented in any of a variety of communication devices including but not limited to a telephone, a Personal Computer (PC), a tablet device, a cellular telephone, a smartphone, a Personal Digital Assistant (PDA), a television, a set-top box, a FAX machine, a pager, and others. It should be noted and understood that, while only six user agents 101/102 are illustrated here for the sake of simplicity and clarity, any number of user agents may be used with various embodiments described herein.

As illustrated in this example, some of the UAs (e.g., 101A-N) can be located outside of a Software Defined Network (SDN) 112 and some of the UAs (e.g., 102A-N) are within SDN 112. For example, the SDN 112 may comprise a portion a communication network such as the Internet.

The system 100 can include an SDP gateway 111. As known in the art, the SDP gateway 111 may be implemented by or as part of a SIP server (not shown here) which can comprise any hardware/software that can process communications, such as a network server, a Private Branch Exchange (PBX), a Session Manager, a communication system, a router, a central exchange, and/or others. The user agents 101A-N can be coupled with the SDP gateway 111 and each other via one or more communication networks 110A as known in the art such as the Internet, a Wide Area Network (WAN), a Local Area Network (LAN), the Public Switched Telephone Network (PSTN), a packet switched network, a circuit switched network, a cellular network, any combination of these, and the like. The network 110A can use a variety of protocols, such as Ethernet, Internet Protocol (IP), Session Initiation Protocol (SIP), Asynchronous Transfer Mode (ATM), Integrated Services Digital Network (ISDN), H.323, and the like. The SDP gateway 111 can establish a SIP session dialog between the user agents 101A-N located outside of the SDN 112 with user agents 102A-N located inside of the SDN 112 using standard SIP processes.

For example, the user agent 101A may attempt to establish a communication session (e.g., voice call, a video call, a video conference , a voice conference, etc.) with the user agent 102A. However, since the user agent 102A is located within the SDN 112 the user agent 102A may not be visible to the user agent 101A. The user agent 101A sends a SIP registration message directed to the user agent 102A.

The SIP registration message from the user agent 101A is intercepted by the SDP gateway 111 (e.g., the SDP gateway 111 interrupts the user agent 101A's SIP registration attempt to the user agent 102A. The SDP gateway 111/SDP server 130 performs Single Packet Authentication (SPA), if the user agent 101A is permitted to communicate with the user agent 102A (e.g., the user agent is on a whitelist permitted to access the SDN 112). In some embodiments, the whitelist may be stored on the database 120. In other words, the SDP gateway 111 acts a firewall to the SDN 112. As illustrated, the SDP gateway 111 is connected to the SDN 112, but is also accessible by devices outside of the SDN 112 (e.g., the SDP gateway 111 is detectable).

If the user agent 101A is not permitted to communicate with devices located on the SDN 112, the SDP gateway 111 may drop the call (e.g., no connection is setup, and no error message is sent). If the user agent 101A is permitted to connect to the user agent 102A then the SDP gateway 111 provides the user agent 101A with the necessary information/credentials to establish a SIP session with the user agent 102A. For example, the SDP gateway 111 may provide the user agent 101A with access to the SDN 112 (e.g., opening the connection) provide the user agent 101A with the IP address for the user agent 102A, and instruct the user agent 102A that it is ok to responds to the user agent 101A's request. In some embodiments, the whitelist is time-based. For example, to keep the whitelist fresh, the whitelist may be cleared after a certain amount of time (e.g., based on a timer, at the end of each day, etc.), or the device/IP may be removed from the whitelist after a predetermined time since the last message, after the end of the session, etc. In some embodiments, the timer is user configurable. The system (e.g., the SDP gateway 111 and the user agents 102A-N) ignore probes from any device not on the whitelist. In some embodiments, a timer is started when a user agent sends an initial request, and if the timer is not expired before a subsequent request, the initial SIP registration message for the subsequent request may not be intercepted since the user agent is still authorized to communicate with devices located within the SDN 112.

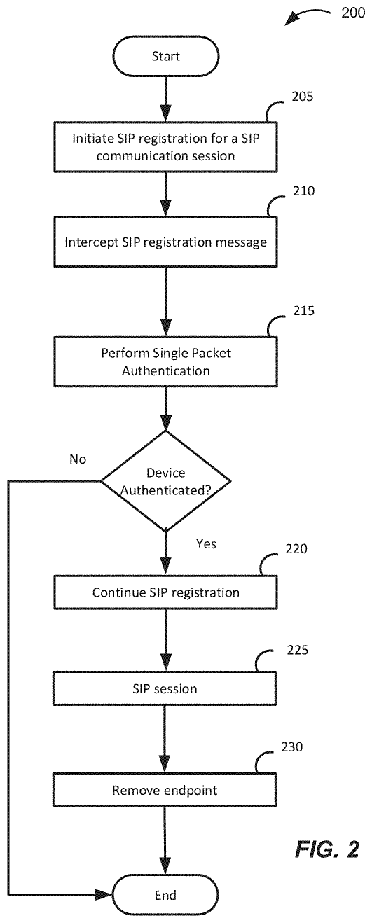

In some embodiments, the functions of the SDP gateway 111/SDP server 130 may be performed using firmware/software only. In other embodiments, the functions of the SDP gateway 111/SDP server 130 may be performed using a hardware addition (e.g., FOC or PoE “box”). Additional details of the processes for improving security of SIP calls in an SDN will now be described with reference to FIGS. 2-5.

FIG. 2 is a flowchart illustrating an exemplary process 200 for improving security of SIP calls in an SDN according to one embodiment. The process 200 may be embodied as an algorithm encoded as machine-readable instructions that, when read by a processor, such as a processor of the SDP gateway 111, cause the processor to execute the steps of the algorithm. In one embodiment, the process 200 causes a system (e.g., an SDP gateway 111/SDP server 130) to intercept a SIP registration message from an initiating device attempting to establish a SIP session with a user agent located within an SDN.

In this example, improving security of SIP calls in the SDN can begin with initiating 205, by a user agent, SIP registration for a SIP communication session. For example, the user agent 101A initiates a SIP registration to establish a SIP communication session with the user agent 102A, which is located on the SDN 112. The SIP registration message is intercepted 210 by the SDP gateway 111/SDP controller 130. The SDP gateway 111/SDP controller 130 performs 315 Single Packet Authentication (SPA) on the initiating agent (e.g., the user agent 101A). For example, the SDP controller 130 checks the database 120 to determine if the user agent 101A is on a whitelist permitted to access the SDN 112. If the initiating user agent (e.g., the user agent 101A) is not authenticated (no) the process 200 ends. In some embodiments, the request (e.g., SIP registration message) is dropped without any notification to the initiating user agent. If the initiating user agent (e.g., the user agent 101A) is authenticated (yes) the process 200 continues 220 the SIP registration. Once the SIP registration is complete, a SIP communication session is established 225. Next in the process 200, the initiating device (e.g., the user agent 101A) is removed 230 from the whitelist. In some embodiments, the initiating device is removed from the whitelist once the SIP communication session is concluded. In other embodiments, the initiating device is removed after a predetermine amount of time has elapsed.

Although the method described in FIG. 2 is shown in a specific order, one of skill in the art would recognize that the steps in FIG. 2 may be implemented in different orders and/or be implemented in a multi-threaded environment. Moreover, various steps may be omitted or added based on implementation.

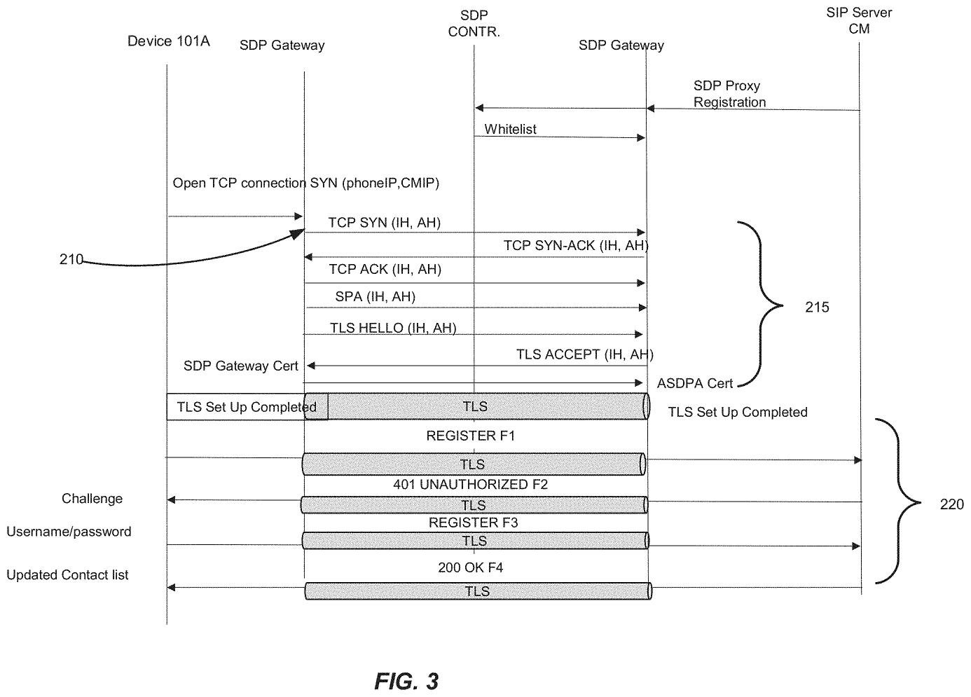

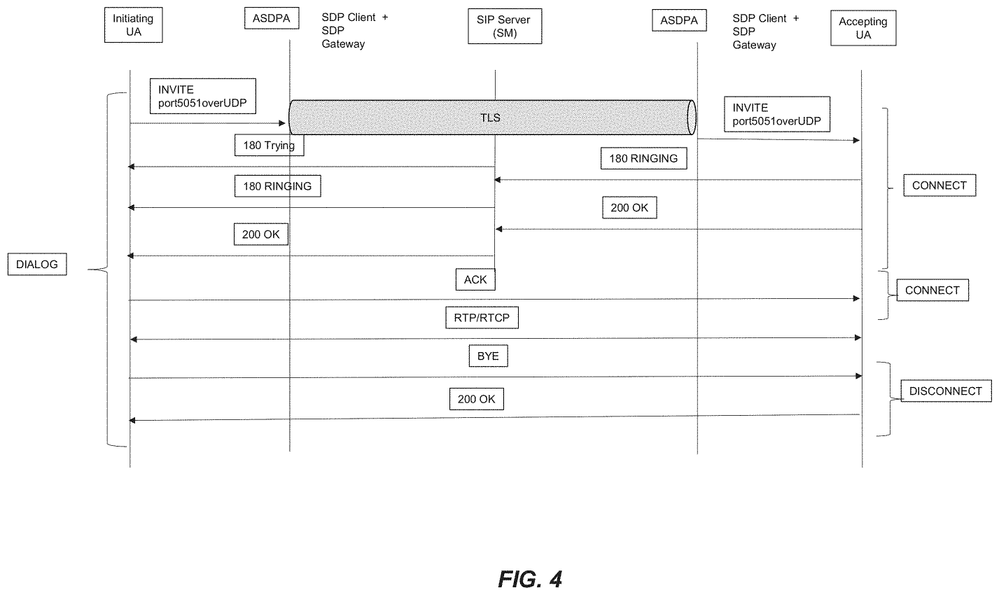

FIGS. 3-4 is a fencepost diagram illustrating one example of signaling between elements of a system.

FIG. 4 is a fencepost diagram illustrating one example of signaling between elements of a system for improving security of SIP calls in an SDN according to one embodiment. More specifically, this example illustrates an exchange of signaling messages between elements of a system to initiate a dialog. The elements involved here include a user agent (101A) which initiates a call and will therefore also be referred to here as the initiating UA. The elements also include an SDP gateway, an SDP controller, a second SDP gateway, and a SIP server. It should be noted that, while illustrated here as separate for the sake of clarity, the SDP gateway associated with the initiating UA and the SDP gateway associated with the terminating UA are separated by the SDP controller may, depending upon the exact implementation, be the same or different physical and/or virtual equipment or machine.

Similarly, the SIP server may, in some cases, be physically or virtually implemented as part of or co-located with either or both of the SDP gateways and/or the SDP controller. Also, it should be understood that for the sake of simplicity and clarity, any number of additional elements may be included in various implementations. Other variations on the arrangement and/or composition of the elements involved in improving security of SIP calls in an SDN are contemplated and considered to be within the scope of the present disclosure.

Prior to the initiating UA 101A initiating a call, the SDP server registers with the SDP controller and receives a whitelist. To initiate the call, the initiating UA 101A can generate and send a SIP INVITE message. The SDP gateway associated with the initiating UA intercepts the SIP INVITE message (e.g., interrupts the SIP registration). For example, step 210 of the process 200. Next, FIG. 3 illustrates the signaling associated with the step 215 of the process 200 to perform the single packet authentication of the initiating UA 101A. If the initiating UA 101A is not authenticated (e.g., not on the whitelist), the signaling would terminate. However, FIG. 3 illustrates the step 220 of the process 200 where the signaling returns to performing the SIP registration. For example, the SDP gateway for the initiating UA 101A can then forward the SIP INVITE message to the other elements of the system including the terminating UA (not shown).

FIG. 4 illustrates the normal SIP signaling/dialog to set up a SIP session.

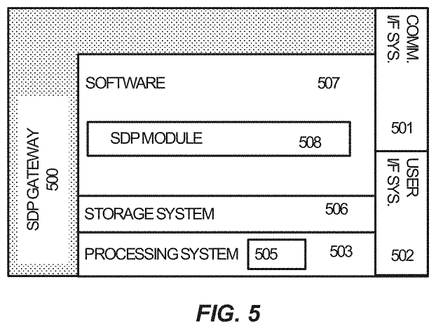

FIG. 5 is block diagram illustrating a computing device 500 in accordance with embodiments of the present disclosure. The computing device 500 improves security of SIP calls in SDNs. Similar computing systems may be included in SDP gateway 111, in whole or in part, described herein to improve security of SIP calls in SDNs.

A computing system 500 is representative of any computing system or systems with which the various operational architectures, processes, scenarios, and sequences disclosed herein to improve security of SIP calls in SDNs, comprising various components and connections to other components and/or systems.

The computing system 500 is an example of the SDP gateway 111, although other examples may exist. The computing system 500 comprises a communication interface 501, a user interface module 502, and a processing system 503. The processing system 503 is linked to the communication interface 501 and user interface module 502. The processing system 503 includes a microprocessor and/or processing circuitry 505 and a storage system 506 that stores operating software 507. The computing system 500 may include other well-known components such as a battery and enclosure that are not shown for clarity. The computing system 500 may comprise a server, a user device, a desktop computer, a laptop computer, a tablet computing device, or some other user communication apparatus.

The communication interface 501 comprises components that communicate over communication links, such as network cards, ports, radio frequency (RF), processing circuitry and software, or some other communication devices. Communication interface 501 may be configured to communicate over metallic, wireless, or optical links. Communication interface 501 may be configured to use Time Division Multiplex (TDM), Internet Protocol (IP), Ethernet, optical networking, wireless protocols, communication signaling, or some other communication format—including combinations thereof. In some implementations, the communication interface 501 is configured to communicate with other end user devices, wherein the communication interface 501 is used to transfer and receive voice and video communications for the devices.

The user interface module 502 comprises components that interact with a user. The user interface module 502 may include a speaker, microphone, buttons, lights, display screen, touch screen, touch pad, scroll wheel, communication port, or some other user input/output apparatus—including combinations thereof. The user interface module 502 may be omitted in some examples.

The processing circuitry 505 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via a bus, executes instructions, and outputs data, again such as via the bus. In other embodiments, the processing circuitry 505 may comprise a shared processing device that may be utilized by other processes and/or process owners, such as in a processing array or distributed processing system (e.g., “cloud,” farm, etc.). It should be appreciated that the processing circuitry 505 is a non-transitory computing device (e.g., electronic machine comprising circuitry and connections to communicate with other components and devices). The processing circuitry 505 may operate a virtual processor, such as to process machine instructions not native to the processor (e.g., translate the Intel® 9xx chipset code to emulate a different processor's chipset or a non-native operating system, such as a VAX operating system on a Mac), however, such virtual processors are applications executed by the underlying processor and the hardware and other circuitry thereof.

The processing circuitry 505 comprises a microprocessor and other circuitry that retrieves and executes the operating software 507 from the storage system 506. The storage system 506 may include volatile and nonvolatile, removable, and non-removable media implemented in any method or technology for storage of information, such as computer readable instructions, data structures, program modules, or other data. The storage system 506 may be implemented as a single storage device, but may also be implemented across multiple storage devices or sub-systems. The storage system 506 may comprise additional elements, such as a controller to read the operating software 507. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

The processing circuitry 505 is typically mounted on a circuit board that may also hold the storage system 506 and portions of the communication interface 501 and the user interface module 502. The operating software 507 comprises computer programs, firmware, or some other form of machine-readable program instructions. The operating software 507 includes an SDP module 508, although any number of software modules within the application may provide the same operation. For example, the operating software 507 may include separate modules for authentication, whitelisting, timing, etc. The operating software 507 may further include an operating system, utilities, drivers, network interfaces, applications, or some other type of software. When executed by the processing circuitry 505, the operating software 507 directs the processing system 503 to operate the computing device 500 as described herein.

In at least one implementation, the SDP module 508, when read and executed by the processing system 503, directs the processing system 503 to monitor for and intercept SIP registrations messages. The SDP module 508 when read and executed by the processing system 503, may further direct the processing system 503 to determine if the user agent transmitting the SIP registration message is permitted to communicate with the receiving user agent located within the SDN (e.g., on a whitelist). The SDP module 508 when read and executed by the processing system 503, may further direct the processing system 503 to manage a whitelist for the SDN, including removing devices after a predetermined amount of time.

It should be appreciated that computer readable data may be sent, received, stored, processed, and presented by a variety of components. It should also be appreciated that components illustrated may control other components, whether illustrated herein or otherwise.

Ones of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits.

Additionally, or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion co-microprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJS™ microprocessors, any other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this disclosure have been described in relation to communications systems and components and methods for improving security of SIP calls in SDNs. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

For example, in one alternative embodiment, a system comprising: a communication network including a Software Defined Network (SDN) portion; and a Software Defined Perimeter (SDP) gateway coupled with the SDN portion, the SDP gateway comprising a processor and a memory, the memory comprising a set of instructions stored therein which, when executed by the processor, causes the processor to: intercept a message for a Session Initiation Protocol (SIP) registration from an initiating host to an accepting host for a SIP communication session, wherein the accepting host is located in the SDN portion; perform Single Packet Authentication (SPA) to determine if the initiating host is approved; in response to the initiating host being approved, adding the initiating host to a whitelist for the SDN portion; and instruct the accepting host to accept a communication request from the initiating host for the SIP communication session.

In another alternative embodiment, a method for authenticating an initiating host for a SIP communication session, the method comprising: intercepting a message for a Session Initiation Protocol (SIP) registration from an initiating host to an accepting host for a SIP communication session, wherein the accepting host is located in a Software Defined Network (SDN); performing Single Packet Authentication (SPA) to determine if the initiating host is approved; in response to the initiating host being approved, adding the initiating host to a whitelist for the SDN; and instructing the accepting host to accept a communication request from the initiating host for the SIP communication session.

In another alternative embodiment, a non-transitory computer-readable medium comprising processor-executable instructions, the processor-executable instructions when executed by a processor, causes the processor to: authenticate an initiating host for a SIP communication session; intercept a message for a SIP registration from the initiating host to an accepting host for the SIP communication session, wherein the accepting host is located in a Software Defined Network (SDN); perform Single Packet Authentication (SPA) to determine if the initiating host is approved; in response to the initiating host being approved, adding the initiating host to a whitelist for the SDN; and instruct the accepting host to accept a communication request from the initiating host for the SIP communication session.

Aspects of the embodiments include the initiating host comprising a client device and the accepting host comprising a server device.

Aspects of the embodiments include the initiating host comprising a SIP server device and the accepting host comprising a SIP server device.

Aspects of the embodiments include the initiating host comprising a SIP client device and the accepting host comprising another SIP client device.

Aspects of the embodiments include the initiating host comprising one of a router, switch, or gateway device.

Aspects of the embodiments include the message for the SIP registration comprising a SIP INVITE message from the initiating host.

Aspects of the embodiments include the SDP gateway removing the initiating host from the whitelist for the SDN portion based on a session activity timer.

Aspects of the embodiments include the session activity timer begins when the SIP communication session between the initiating host and the accepting hosts ends.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a communication network including a Software Defined Network (SDN) portion; and
a Software Defined Perimeter (SDP) gateway coupled with the SDN portion, the SDP gateway comprising a processor and a memory, the memory comprising a set of instructions stored therein which, when executed by the processor, causes the processor to:
intercept a message for a Session Initiation Protocol (SIP) registration from an initiating host to an accepting host for a SIP communication session, wherein the accepting host is located in the SDN portion;
perform Single Packet Authentication (SPA) to determine if the initiating host is approved;
in response to the initiating host being approved, adding the initiating host to a whitelist for the SDN portion; and
instruct the accepting host to accept a communication request from the initiating host for the SIP communication session.

2. The system according to claim 1, wherein the initiating host comprises a SIP client device and the accepting host comprises a SIP server device.

3. The system according to claim 1, wherein the initiating host comprises a SIP server device and the accepting host comprises another SIP server device.

4. The system according to claim 1, wherein the initiating host comprises a SIP client device and the accepting host comprises another SIP client device.

5. The system according to claim 1, wherein the initiating host comprises one of a router, switch, or gateway device.

6. The system according to claim 1, wherein the message for the SIP registration comprises a SIP INVITE message from the initiating host.

7. The system according to claim 1, further comprising:
the SDP gateway removing the initiating host from the whitelist for the SDN portion based on a session activity timer.

8. The system according to claim 7, wherein the session activity timer begins when the SIP communication session between the initiating host and the accepting hosts ends.

9. A method for authenticating an initiating host for a SIP communication session, the method comprising:
intercepting a message for a Session Initiation Protocol (SIP) registration from an initiating host to an accepting host for a SIP communication session, wherein the accepting host is located in a Software Defined Network (SDN);
performing Single Packet Authentication (SPA) to determine if the initiating host is approved;
in response to the initiating host being approved, adding the initiating host to a whitelist for the SDN; and
instructing the accepting host to accept a communication request from the initiating host for the SIP communication session.

10. The method according to claim 9, wherein the initiating host comprises a SIP client device and the accepting host comprises a SIP server device.

11. The method according to claim 9, wherein the initiating host comprises a SIP server device and the accepting host comprises another SIP server device.

12. The method according to claim 9, wherein the initiating host comprises a SIP client device and the accepting host comprises another SIP client device.

13. The method according to claim 9, wherein the initiating host comprises one of a router, switch, or gateway device.

14. The method according to claim 9, wherein the message for the SIP registration comprises a SIP INVITE message from the initiating host.

15. The method according to claim 9, further comprising: removing the initiating host from the whitelist for the SDN based on a session activity timer.

16. The method according to claim 15, wherein the session activity timer begins when the SIP communication session between the initiating host and the accepting hosts ends.

17. A computer-readable medium comprising a set of instructions stored therein which, when executed by a processor, causes the processor to authenticate an initiating host for a SIP communication session:
intercept a message for a SIP registration from the initiating host to an accepting host for the SIP communication session, wherein the accepting host is located in a Software Defined Network (SDN);
perform Single Packet Authentication (SPA) to determine if the initiating host is approved;
in response to the initiating host being approved, adding the initiating host to a whitelist for the SDN; and
instruct the accepting host to accept a communication request from the initiating host for the SIP communication session.

18. The computer-readable medium according to claim 18, wherein the set of instructions stored therein which, when executed by the processor, further causes the processor to:
remove the initiating host from the whitelist for the SDN based on a session activity timer.

19. The computer-readable medium according to claim 19, wherein the session activity timer begins when the SIP communication session between the initiating host and the accepting hosts ends.

20. The computer-readable medium according to claim 18, wherein the initiating host comprises a server device and the accepting host comprises a server device.
